(19) United States
(12) Patent Application Publication
(10) Pub. No.: US 2012/0049411 A1
(43) Pub. Date: Mar. 1, 2012

(54) METHOD FOR MANUFACTURING A COMPOSITE MATERIAL CONNECTING ROD

(75) Inventors: Richard Masson, Les Loges En Josas (FR); Patrick Dunleavy, Palaiseau (FR)

(73) Assignee: MESSIER-BUGATTI-DOWTY, VELIZY VILLACOUBLAY (FR)

(21) Appl. No.: 13/266,223

(22) PCT Filed: May 18, 2010
(86) PCT No.: PCT/EP10/56828

§ 371 Date: Nov. 7, 2011

(30) Foreign Application Priority Data
May 20, 2009 (FR) 09 02460

(51) Int. Cl. B29C 39/02

(52) U.S. Cl. 264/299

(57) ABSTRACT

The present invention relates to a method of fabricating a rod of composite material from a fiber preform comprising a certain number of primary fiber plies connected together by links allowing plies to slide relative to one another while the preform is being shaped, the preform including a central portion for constituting the body of the rod and including two opposite side portions, together with extensions for forming lugs of the rod, which method includes the step of shaping the fiber preform so as to give it a hollow shape while keeping the two opposite side portions spaced apart so as to give the fiber preform an open profile in its central portion, followed by injecting resin and causing it to polymerize.

The present invention relates to a method of fabricating a rod of composite material, and to a rod obtained by implementing the method.

The invention finds an advantageous application in the field of aviation and in particular the resulting rod may be incorporated in an undercarriage.

Nevertheless, although the rod is more particularly intended for such an application, it could also be used in other fields, in particular those that require rods that present a large ratio of strength over weight.

### BACKGROUND OF THE INVENTION

In general, a composite rod having a hollow body is obtained by winding filaments around a mandrel or by winding a ply of woven fibers. When made in that kind of way, the thickness of the body of the rod is obtained by acting on the number of wound layers of yarns or plies. In that type of embodiment, the various profiles that can be made for the rod are limited, and in particular its section is necessarily closed.

French document FR 2 893 683 filed by the Applicant discloses in particular a second method of fabricating a rod of composite material for use in the field of aviation. In order to make that rod, a pattern is used that presents two opposite side portions, the pattern being cut out from a composite fiber fabric made up of a plurality of primary plies that are superposed and linked together in such a manner that the primary plies are capable of sliding relative to one another during shaping. The method described in that document includes a step in which the chamfered side portions are covered in order to make a junction in very strong manner.

In that second method of fabrication, the compression and buckling strength of the rod is obtained in particular because of its closed section that enables weight to be saved.

The fabrication method is satisfactory, but complex in that it involves positioning and joining the opposite side portions together. The various rod profiles that can be made by that method are limited in the same manner as the first above-mentioned method.

A third method of fabricating a composite rod is also known, as described in application WO 2009/000925, in which two shells are made that, when assembled together, serve to constitute the body of the rod, thereby creating a closed right section providing the rod with mechanical strength in traction and in compression. Each shell is made by depositing preimpregnated fibers in various forms such as roving, unidirectional sheets, or indeed woven sheets. The complex operation of assembling the two shells together may be performed in particular by adhesive or by using mechanical fasteners.

### OBJECT OF THE INVENTION

An object of the present invention is to propose a method of fabricating a composite rod, which method is simplified compared with prior methods.

### SUMMARY OF THE INVENTION

To this end, the present invention provides a method of fabricating a rod of composite material from a fiber preform comprising a certain number of primary fiber plies connected together by links allowing plies to slide relative to one another while the preform is being shaped, the preform including a central portion for constituting the body of the rod and including two opposite side portions, together with extensions for forming lugs of the rod, which method includes the step of shaping the fiber preform while keeping the two opposite side portions spaced apart so as to give the fiber preform an open profile in its central portion, followed by injecting resin and causing it to polymerize.

The method of the invention thus makes it possible to fabricate a rod in which the body presents an open section making it possible to eliminate the step of assembling together the side portions, and consequently considerably simplifying the fabrication of the rod. Unlike the method described in document WO 2009/000925, the rod in this method is essentially completed after the resin has been injected, and its body remains open, without there being any need to associate it with a second shell of open section. Naturally, it is still necessary to machine the ends of the preform in order to form the lugs.

### BRIEF DESCRIPTION OF THE DRAWINGS

The present invention can be better understood on reading the following description of a detailed embodiment given with reference to the accompanying drawings by way of non-limiting example, in which:

FIG. 1 shows a perspective view of an embodiment of a composite rod in accordance with the invention;

FIG. 2 is a diagrammatic view of an embodiment of a fiber preform laid out flat and suitable for obtaining the rod shown in FIG. 1;

FIG. 3 is a cross-section view of the rod through its body;

FIG. 4 is a plan view of a rod 1 fitted with pins; and

FIG. 5 shows an undercarriage in which a side brace includes a rod of the invention.

### DETAILED DESCRIPTION OF THE INVENTION

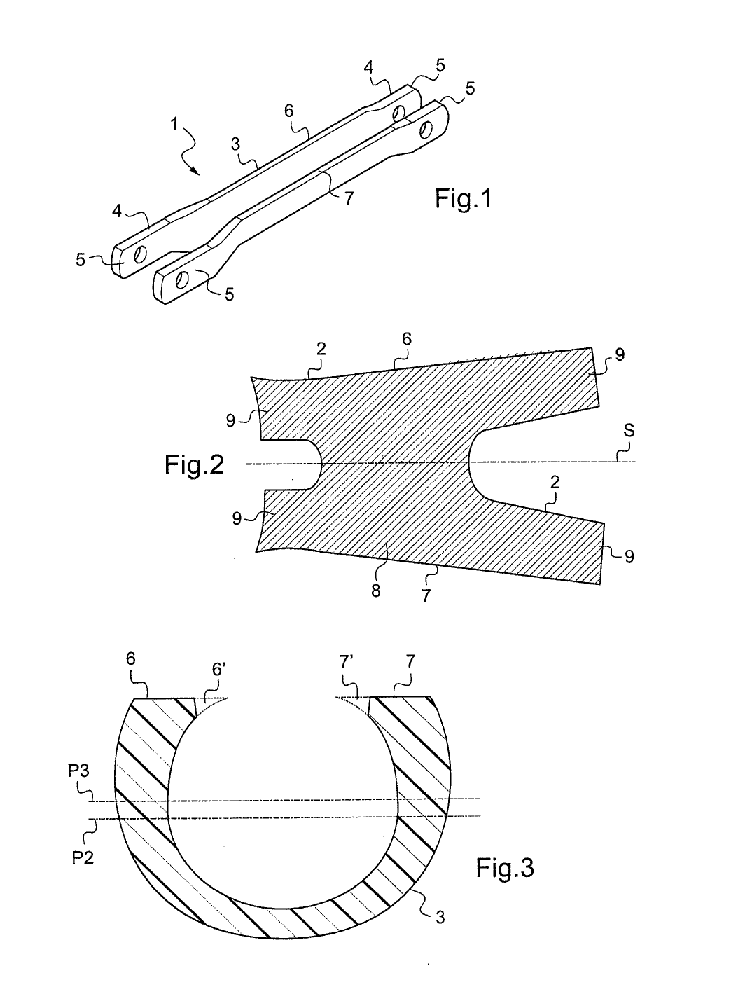

FIG. 1 shows a composite rod 1 of the invention obtained from a fiber preform 2 as shown in FIG. 2. The composite rod 1 is advantageously used as an element of an undercarriage, for example as a side-brace arm, as shown in FIG. 5.

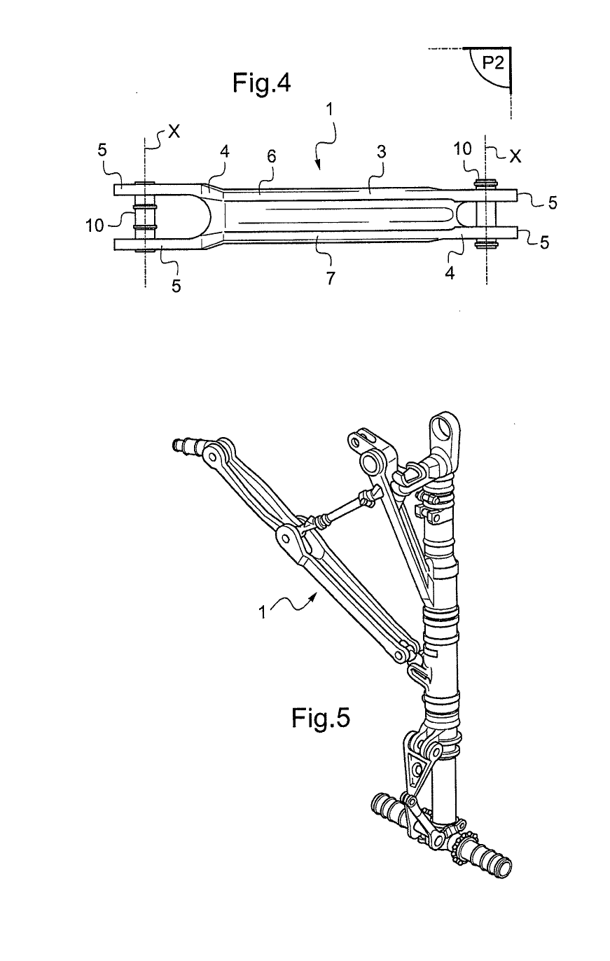

The composite rod 1 comprises a body 3 having a main segment of open or “channel” section, with a fork 4 at each end. Each fork 4 comprises two lugs 5 that face each other and that serve, as shown in FIG. 4, to receive a pin 10 for connection to other structural elements.

According to the invention, the rod 1 is fabricated as follows. The fiber preform 2 is initially cut from a fabric, preferably a fabric of fibers woven in three directions. One technique for fabricating the fabric of the fiber preform 2 is described in document FR 2 893 683 that represents the technological background of the invention. The technique of fabricating the fiber preform 2 (or pattern) as described in that document can be used in the context of the invention, and the content of that document should be considered as forming part of the present application. The fiber fabric preferably comprises a plurality of primary plies of weft fibers that are connected together by warp fibers that extend from one primary ply to another in order to interlink the primary plies. Interlinking the primary plies in this way enables them to be secured to one another while allowing relative sliding between the primary plies while the fiber preform 2 is being shaped, and more particularly while it is being curved. The preform 2 is preferably cut from the fabric in such a manner that the weft yarns extend in a plane of symmetry S of the fiber preform 2. The fiber preform 2 includes a central portion 8 that is to constitute the body 3 with two opposite side portions 6 and 7 and four extensions 9 for forming the lugs.

Thereafter, the preform is shaped so as to give the central portion 8 a hollow shape by folding the two opposite side portions 6 and 7 of the fiber preform 2 one over the other while keeping them apart. The central portion is advantageously given a main segment having a C-shaped channel section as shown in FIG. 3. Preferably, shaping is performed by wrapping the fiber preform 2 around a mandrel. With other types of open section member, for example that present a channel of U-shape or of V-shape, the fiber preform 2 may be folded, wrapped, or curved in order to form rods in which the body may thus present a variety of shapes of open section in which the side portions 6 and 7 are kept apart.

The extensions 9 then extend facing each other in pairs in parallel planes, and they serve naturally to form the lugs of the rod.

The method then comprises a resin-injection step. This step is advantageously performed using the known method of resin transfer molding (RTM) in which the resin impregnates the fibers of the fiber preform 2.

For this purpose, while it is shaped on the mandrel, the preform is advantageously placed in a mold that is closed and filled with resin by the RTM method. The assembly is then heated to cause the resin to polymerize. In a variant, it would equally well be possible to use resin infusion methods.

A solid hollow shape is thus obtained that presents a central body of open section that is terminated by extensions that merely need to be machined (contouring and drilling) in order to form the lugs of the rod, as shown in FIG. 1. The operation is terminated by placing inserts in the orifices in the lugs.

The method of the invention thus makes it possible to eliminate the step of assembling together the side portions of the preform, and it does not require one or more other additional shells to be made for the purpose of being assembled to the hollow shape.

In addition, the open-section rod is less rigid in twisting than is a rod of closed section, and this may be advantageous in the context of using such a rod as a side-brace arm. An undercarriage leg together with the corresponding wing or fuselage structure may deform significantly, and the flexibility in twisting of such a rod makes it easier to accommodate such deformation.

Naturally, it is known that the compression strength of an elongate body of open section is less than that of an elongate body of closed section for similar wall thickness and diameter. It is therefore appropriate to design the structure suitably to ensure that the resulting rod has the desired compression strength.

In particular, it is advantageous to ensure that the plane on which forces are introduced into the rod, i.e. the plane P2 containing the central axes X of the lugs 5, as can be seen in FIG. 4, extends as close as possible to a parallel plane P3 passing through the centers of inertia of the sections of the main segment of the body, and preferably between the plane P3 and the bottom of the body of the rod, as shown in FIG. 4. Ideally, the planes P2 and P3 coincide.

It is also advantageous to stiffen the side portions 6 and 7 in order to increase the local buckling strength of the side portions of the rod.

To this end, and in a particular embodiment, a fiber preform 2 is used of thickness that varies, at least in a direction to the plane of symmetry S of the preform.

As can be seen in FIG. 3, the side portions 6 and 7 are thicker than the portion of the preform 2 that is close to its plane of symmetry.

Such varying thickness may be obtained in several ways. Firstly, this variation in thickness may be obtained by weaving. Furthermore, the preform 2 may be cut from a fabric that is thick, having the thickness that corresponds to the thickness desired for the side portions, and then the preform can be thinned going from the side portions towards the plane of symmetry, e.g. by abrasion or by cutting the fibers that are to be removed. In a second technique, the preform is cut from a fabric of thickness that corresponds to the smallest thickness of the rod body, and the side portions are thickened by interposing intermediate fiber plies between the primary plies of the fabric. Such a reinforcing technique is described in document FR 2 893 683 for reinforcing extensions from the preform, however it can advantageously be used for thickening the side portions of the central portion of the preform.

It should be observed that the particular shape shown in FIG. 3 for the side portions 6, 7 results directly from the curving operation during which the plies of the fabric slide relative to one another and give the side portions the chamfered shape shown. Preferably, after the preform has polymerized, the inwardly-directed corners 6′ and 7′ of the side portions are eliminated by machining (the portions that are eliminated are represented by dashed lines).

Other means may be used for stiffening the side portions 6 and 7, e.g. by making arrangements for folding the side portions parallel to each other so that they present dropped edges or rims that, once the assembly has polymerized, contributes to stabilizing the side portions, like dropped edges of a panel.

The method of fabrication thus presents significant advantages compared with prior techniques including that of enabling a rod to be made using a simplified method that allows a wide variety of open profile shapes to be used, and in particular channel sections that are C-, U-, or indeed V-shaped, while ensuring high levels of mechanical strength that enable the resulting rod to be used as a foldable undercarriage side brace, as shown in FIG. 5.

Other characteristics of the invention may also be envisaged without thereby going beyond the ambit of the invention as defined by the following claims.

In particular, although the invention consists in leaving the section of the rod body open so as to eliminate an operation of connecting the side portions together, it is nevertheless possible to stabilize them by providing one or more ties extending from one side portion to the other, e.g. a plane rigid thin wall fitted onto the two side portions and secured thereto. Such reinforcement does not have any structural function other than stabilizing the side portions so as to reduce their tendency to buckle locally. In particular, they contribute very marginally or not at all to the traction strength of the rod.

1. A method of fabricating a rod of composite material from a fiber preform (2) comprising a certain number of primary fiber plies connected together by links allowing plies to slide relative to one another while the preform is being shaped, the preform including a central portion (8) for constituting the body of the rod and including two opposite side portions (6, 7), together with extensions (9) for forming lugs of the rod, which method includes the step of shaping the fiber preform so as to give it a hollow shape while keeping the two opposite side portions spaced apart so as to give the fiber preform an open profile in its central portion, followed by injecting resin and causing it to polymerize.

2. A method according to claim 1, wherein the fiber preform is wrapped around a shaper mandrel before injecting resin and polymerizing it.

3. A method according to claim 1, wherein the side portions are stiffened to increase local buckling strength.

4. A method according to claim 3, wherein the stiffening comprises using a preform of varying stiffness that increases perpendicularly to a plane of symmetry of the preform on going from the center thereof towards the side portions (6, 7).

5. A method according to claim 1, wherein the preform is shaped in such a manner that a force introduction plane (P2) passing via the axes of the lugs of the finished rod extends under or coincides with a parallel plane (P3) containing the centers of inertia of the sections of the body of the rod.
